(19) United States
(12) Patent Application Publication
(10) Pub. No.: US 2005/0252974 A1
(43) Pub. Date: Nov. 17, 2005

(54) Information delivery system transmitting information corresponding to identifier acquired by analyzing data image of barcode

(75) Inventor: Akiya Mizukoshi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION

(21) Appl. No.: 11/129,284

(22) Filed: May 16, 2005

(30) Foreign Application Priority Data
May 17, 2004 (JP) 2004-146316

(51) Int. Cl. G06F 17/00; G06F 19/00

(52) U.S. Cl. 235/462.15

(57) ABSTRACT

An information delivery system according to an embodiment of the invention is configured with a communication terminal and a server. The communication terminal includes a camera capable of taking an image of a barcode storing an identifier, an analyzer analyzing image data of the barcode taken by the camera to acquire the identifier, and a transmitter transmitting the identifier acquired by the analyzer. The server includes storage storing information in association with identifiers, a receiver receiving the identifier transmitted from the communication terminal, and a transmitter transmitting the information corresponding to the identifier retrieved from the storage to the communication terminal.

### BACKGROUND OF THE INVENTION

1. Field of the Invention

The present invention relates to an information delivery system and an information delivery method in which an information provider server provides a communication terminal with information such as advertisement according to an identification number provided through a barcode placed on the street or the like by an advertiser.

2. Description of Related Art

A user accesses a contents database with a mobile information terminal by inputting an identification code corresponding to an advertising display placed in a telephone pole or building on the street or the like. The contents database supplies image data of a vicinity map including the actual location and a store location of the advertiser corresponding to the identification code transmitted from the mobile information terminal to the user of the mobile information terminal through the Internet. Such an information delivery system is described in Japanese Unexamined Patent Publication No. 2002-328927 (Mizuno et al.).

A barcode reader of the mobile information terminal analyzes a barcode attached to a post or building wall within a service area and storing an area number so as to detect the actual location from the area number. The detected present location and destination are displayed, embedded in the map data which is preset in the mobile information terminal or supplied from a server, on a display of the mobile information terminal. Such a navigation service is described in Japanese Unexamined Patent Publication No. 2003-156360 (Ouchi et al).

However, the technique taught by Mizuno et al. requires a user to input an identification code corresponding to an advertising display by hand in order to receive information, thus taking a lot of trouble.

On the other hand, the technique taught by Ouchi et al. does not require a user to input an identification code by hand. However, this technique requires a user to bring a barcode reader into contact with a barcode in order to read barcode information, thus not being user-friendly.

A mobile information terminal equipped with a GPS locator that detects the position by receiving a GPS signal from a satellite allows easily obtaining the present location of the mobile information terminal. However, it can only obtain positional information, and a user needs to check a building ID number, domain name, URL and so on in order to receive information such as advertisement supplied by an advertiser in the present location.

### SUMMARY OF THE INVENTION

According to one aspect of the present invention, there is provided an information delivery system comprising a communication terminal and a server. The communication terminal includes a camera capable of taking an image of a barcode, an analyzer analyzing image data of the barcode taken by the camera to acquire an identifier embedded in the barcode, a transmitter transmitting the identifier acquired by the analyzer, and a receiver receiving information from outside sources. The server includes a storage storing information in association with identifiers, a receiver receiving the identifier transmitted from the communication terminal, and a transmitter transmitting information associated with the transmitted identifier and retrieved from the storage to the communication terminal.

According to another aspect of the present invention, there is provided an information delivery system comprising a communication terminal and a server. The communication terminal includes a camera capable of taking an image of a barcode, a transmitter transmitting image data of the barcode taken by the camera, and a receiver receiving information from outside sources. The server includes a storage storing information in association with identifiers, a receiver receiving the image data of the barcode from the communication terminal, an analyzer analyzing the image data of the barcode to acquire an identifier embedded in the barcode, and a transmitter transmitting information associated with the acquired identifier and retrieved from the storage to the communication terminal.

According to still another aspect of the present invention, there is provided a information providing server comprising a storage storing information in association with identifiers, a receiver receiving image data of a barcode from a communication terminal, an analyzer analyzing the image data of the barcode to acquire an identifier embedded in the barcode, a transmitter transmitting information associated with the acquired identifier and retrieved from the storage to the communication terminal.

According to another aspect of the present invention, there is provided a communication terminal comprising a camera capable of taking an image of a barcode, an analyzer analyzing image data of the barcode taken by the camera to acquire an identifier embedded in the barcode, a transmitter transmitting the identifier acquired by the analyzer, and a receiver receiving information in association with the identifier from a server.

Thus, the present invention analyzes picked up image data of a barcode to acquire an identifier embedded in the barcode indicating information to be transmitted from a server to a communication terminal, allowing a communication terminal to easily receive information from a server.

### BRIEF DESCRIPTION OF THE DRAWINGS

FIG. 1 is a view showing the configuration of an information delivery system according to a first embodiment of the invention;

FIG. 2 is a sequence diagram to describe the operation of the information delivery system according to the first embodiment of the invention;

FIG. 3 is a view showing the configuration of an information delivery system according to a second embodiment of the invention; and

FIG. 4 is a sequence diagram to describe the operation of the information delivery system according to the second embodiment of the invention.

### DESCRIPTION OF THE PREFERRED EMBODIMENTS

### First Embodiment

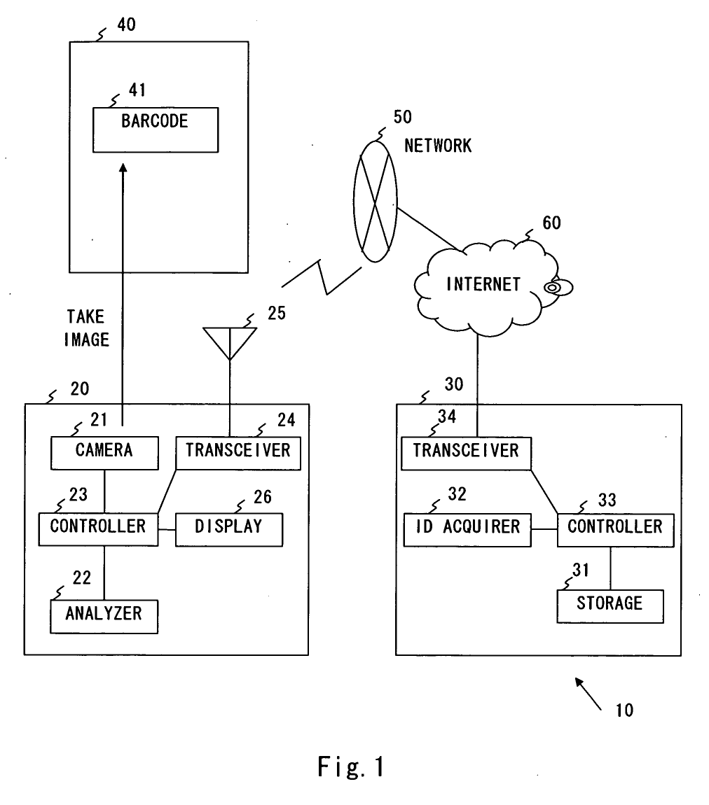

A first embodiment of the present invention is described hereinafter with reference to the drawings. FIG. 1 is a view showing the configuration of an information delivery system according to the first embodiment of the invention.

Referring first to FIG. 1, an information delivery system 10 is composed of a communication terminal 20 such as a mobile telephone or a mobile information terminal with communication function, and a server 30. The communication terminal 20 is connectable to a network 50 such as a telephone network. The server 30 is connected to Internet 60. The communication terminal 20 and the server 30 can be wirelessly connected to each other via the network 50 and the Internet 60. A barcode 41 is attached to a building 40 of an advertiser who is an information providing source. An ID is embedded in the barcode 41 as an identifier of the advertiser or the building 40. The ID may be numbers, symbols, or a combination of these, or it may be a domain name, an address, or the like. The domain name is a code of numbers, symbols, letters, or a combination of these codes, which is assigned to identify each computer in the Internet 60. The barcode 41 may be a one-dimensional barcode or preferably a two-dimensional barcode. The two-dimensional barcode contains information vertically and horizontally and thus contains more information with a smaller area than a conventional one-dimensional barcode. The two-dimensional barcode is made up of a plurality of superimposed one-dimensional barcodes composed of black and white parallel bars of several widths. Thus, if an advertiser desires to store large volume data as an ID in the barcode 41, it is preferred to use the two-dimensional barcode. Japanese Industrial Standards JIS X0510 defines the standard for a QR code, which is a type of the two-dimensional barcode.

The communication terminal 20 comprises a camera 21, an analyzer 22, a controller 23, a transceiver 24, an antenna 25, and a display 26. The camera 21 can at least take an image of a one-dimensional or two-dimensional barcode storing an ID. The analyzer 22 analyzes image data of the barcode 41 taken by the camera 21 with a barcode analyzer software program to acquire an ID. The controller 23 controls all electrical components of the communication terminal 20. The transceiver 24 exchanges data with the server 30 via the antenna 25. Specifically, the transceiver 24 transmits the ID acquired by the analyzer 22 analyzing the image data of the barcode 41 containing the ID taken with the camera 21. Further, the transceiver 24 receives information such as advertisement corresponding to the ID transmitted from a transceiver 34 of the server 30, which is described later. The display 26 displays the information such as advertisement corresponding to the ID transmitted from the server 30, thereby supplying the information to a user.

The server 30 comprises a storage 31, an ID acquirer 32, a controller 33, and a transceiver 34. The transceiver 34 is connected to the Internet 60. Advertisers store information related to the advertisers in association with own IDs into the storage 31. The information related to an advertiser is, for example, advertisement, homepage information, selling product and price information, location information, related stock prices, and so on. The stored information may contain information of shops in the building 40, such as shop names, lines of business, shop phone numbers, shop locations in the building 40, sale information of the shops or the like. When the transceiver 34 of the server 30 receives an ID transmitted from the communication terminal 20, the ID acquirer 32 acquires the ID and stores it temporarily. The controller 33 retrieves the information such as advertisement stored in the storage 31 associated with the ID acquired by the ID acquirer 32. The transceiver 34 transmits the information such as advertisement retrieved by the controller 33 to the communication terminal 20 via the Internet 60 and the network 50.

The operation of the information delivery system according to the first embodiment of the invention is described hereinafter with reference to the drawings.

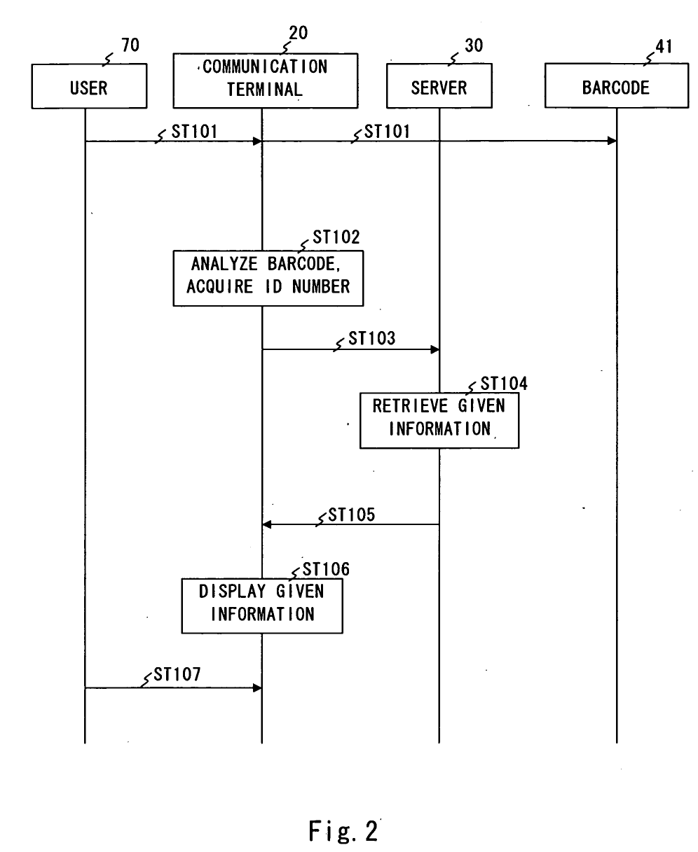

FIG. 2 is a sequence diagram to describe the operation of the information delivery system according to the first embodiment. Referring to FIGS. 1 and 2, a user 70 first takes an image of the barcode 41 attached to the building 40 of the advertiser with the camera 21 of the communication terminal 20 (STEP, hereafter as “ST”, 101). The image data of the barcode 41 taken by the camera 21 is output to the analyzer 22 through the controller 24 of the communication terminal 20. The analyzer 22 resolves the image data of the barcode 41 with a barcode analyzer software program and acquires an ID embedded in the barcode 41 (ST102). Then, the communication terminal 20 is connected to the network 50. The transceiver 24 of the communication terminal 20 transmits the ID acquired by the analyzer 22 to the server 30 through the antenna 25 via the network 50 and the Internet 60 (ST103). Then, the transceiver 34 of the server 30 receives the ID from the communication terminal 20. The ID acquirer 32 acquires the ID through the controller 33 and stores it temporarily. The controller 33 may include the function of the ID acquirer 32. After that, the controller 33 of the server 30 searches for the corresponding ID in the storage 31. If the corresponding ID is found, the controller 33 of the server 30 retrieves information such as advertisement corresponding to the ID number from the storage 31 (ST104). Then, the transceiver 34 of the server 30 transmits the information such as advertisement retrieved from the storage 31 by the controller 33 to the communication terminal 20 via the Internet 60 and the network 50 (ST105). If the corresponding ID does not exist in the storage 31, the transceiver 34 of the server 30 informs the communication terminal 30 that no corresponding information is found. If the information corresponding to the ID is found, the transceiver 24 of the communication terminal 20 receives the information from the server 30. The controller 23 of the communication terminal 20 makes the information displayed on the display 26 (ST106). The user 70 thereby receives the information such as advertisement displayed on a screen of the display 26 of the communication terminal 20 (ST107).

The user 70 pays communication charges depending on time. The advertiser pays advertising charges depending on the number of accesses to the server 30 to an administrator of the server 30.

In this way, the information delivery system of the first embodiment allows the communication terminal 20 to easily receive information from the server 30.

Further, since this embodiment takes the image of the barcode 41 with the camera 21 and acquires the ID stored in the barcode 41, it is possible to easily acquire the ID stored in the barcode 41 by taking the image of the barcode 41 in the imageable range of the camera 21.

Furthermore, since this embodiment takes the image of the barcode 41 with the camera 21 and acquires the ID stored in the barcode 41, it is possible to acquire the ID stored in the barcode 41 with the communication terminal 20 such as an existing general mobile phone with camera without adding a barcode reader.

It is feasible to build an information delivery system by configuring the communication terminal 20 and the server 30 with an Internet connectable system and using a domain name used in Internet connection, as an identifier. This configuration allows connecting the communication terminal 20 and the server 30 with a general-purpose system without configuring a special system.

The information stored in the storage 31 of the server 30 may contain the address of the building 40 or a map containing the building 40 and its neighborhood. This allows a user of the communication terminal to easily check the present location from the given information received from the server even if the communication terminal is not equipped with a GPS locater.

The barcode 41 storing the ID may be a two-dimensional barcode. This allows information of an ID to contain large volume letters and symbols including Chinese characters.

### Second Embodiment

A second embodiment of the present invention is described hereinafter with reference to the drawings.

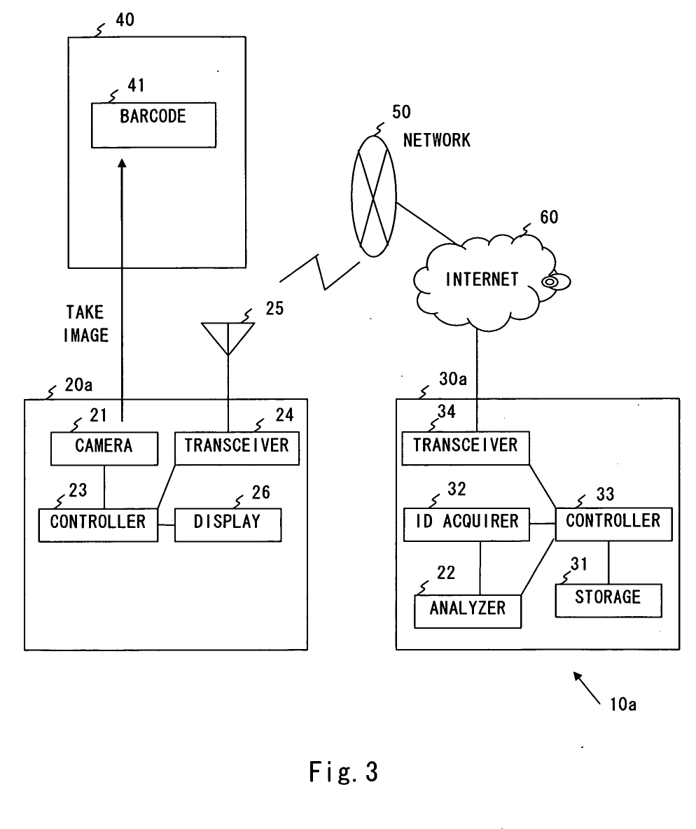

FIG. 3 is a view showing the configuration of an information delivery system according to the second embodiment.

As shown in FIG. 3, an information delivery system 10a is composed of a communication terminal 20a and a server 30a. An analyzer 36 is placed in the server 30a, which is different from the first embodiment. The operation of the information delivery system of this embodiment is described below.

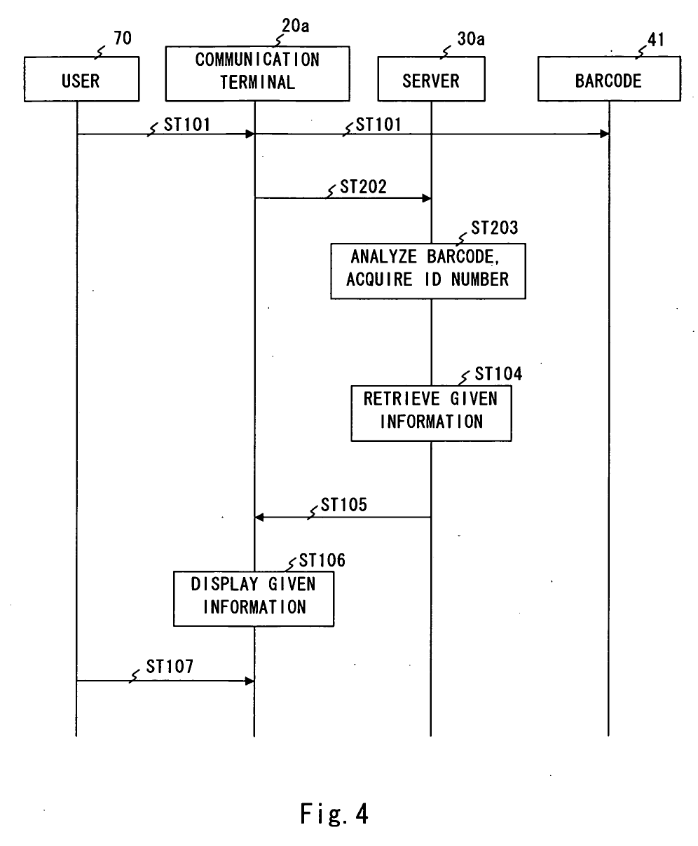

FIG. 4 is a sequence diagram to describe the operation of the information delivery system according to the second embodiment. Though the first embodiment performs the process of analyzing the image data of the barcode 41 and acquiring the ID stored in the barcode 41 in the analyzer 22 implemented in the communication terminal 20 as shown in FIG. 2, this embodiment performs that process in the analyzer 36 in the server 30a as shown in FIG. 4. Referring to FIGS. 3 and 4, the user 70 takes an image of the barcode 41 (ST 101). Then, the transceiver 24 of the communication terminal 20a transmits the image data of the barcode 41 to the server 30a through the antenna 25 via the network 50 and the Internet 60 (ST202). The transceiver 34 of the server 30a receives the image data of the barcode 41 transmitted from the communication terminal 20a. Then, the analyzer 36 resolves the image data of the barcode 41 with a barcode analyzer software program. The ID acquirer 32 acquires the ID embedded in the barcode 41 and stores it temporarily (ST203). The controller 33 searches for the corresponding ID in the storage 31 according to the ID stored temporarily in the ID acquirer 32, and retrieves information such as advertisement corresponding to the ID number from the storage 31 (ST104). Then, the transceiver 34 of the server 30a transmits the information such as advertisement retrieved from the storage 31 to the communication terminal 20a via the Internet 60 and the network 50 (ST105). The transceiver 24 of the communication terminal 20 receives the information such as advertisement from the server 30a. The controller 23 of the communication terminal 20a controls such that the information is displayed on the display 26 (ST106). The user 70 thereby receives the given information such as advertisement displayed on a screen of the display 26 of the communication terminal 20a (ST107).

In this way, the information delivery system of the second embodiment also allows the communication terminal 20a to easily receive information from the server 30a. Since the analyzer 36 is installed in the server 30a, this embodiment is effective when it is impossible to implement an analyzer in the communication terminal 20a due to memory size or the like.

It is apparent that the present invention is not limited to above embodiment, that may be modified and changed without departing from the scope and spirit of invention.

1. A communication terminal comprising:
a camera capable of taking an image of a barcode,
an analyzer analyzing image data of the barcode taken by the camera to acquire an identifier embedded in the barcode,
a transmitter transmitting the identifier acquired by the analyzer, and
a receiver receiving information in association with the identifier from a server.

2. The communication terminal of claim 1, wherein the identifier is a domain name used for internet connection, and the communication terminal is an internet connectable terminal.

3. The communication terminal of claim 1, wherein the communication terminal receives advertisement information associated with the identifier from a server.

4. The communication terminal of claim 1, wherein the communication terminal further includes a display displaying the information corresponding to the identifier transmitted from the server.

5. The communication terminal of claim 1, wherein the barcode is a two-dimensional barcode.

6. An information providing server comprising:
a storage storing information in association with identifiers,
a receiver receiving image data of a barcode from a communication terminal,
an analyzer analyzing the image data of the barcode to acquire an identifier embedded in the barcode,
a transmitter transmitting information associated with the acquired identifier and retrieved from the storage to the communication terminal.

7. The information providing server of claim 6, wherein the identifier is a domain name used for internet connection.

8. The information providing server of claim 6, wherein the storage stores advertisement information in association with identifiers, and advertisement information associated with the identifier is transmitted to the communication terminal.

9. The information providing server of claim 6, wherein the barcode is a two-dimensional barcode.

10. An information delivery system comprising:
a communication terminal of claim 1; and
a server including
a storage storing information in association with identifiers,
a receiver receiving the identifier transmitted from the communication terminal, and
a transmitter transmitting information associated with the transmitted identifier and retrieved from the storage to the communication terminal.

11. The information delivery system of claim 10, wherein the identifier is a domain name used for internet connection, and the communication terminal is an internet connectable terminal.

12. The information delivery system of claim 10, wherein the storage stores advertisement information in association with identifiers, and advertisement information associated with the transmitted identifier is transmitted to the communication terminal.

13. The information delivery system of claim 10, wherein the communication terminal further includes a display displaying the information corresponding to the identifier transmitted from the server.

14. The information delivery system of claim 10, wherein the barcode is a two-dimensional barcode.

15. An information delivery system comprising:
an information providing server of claim 6; and
a communication terminal including
a camera capable of taking an image of a barcode,
a transmitter transmitting image data of the barcode taken by the camera to the server, and
a receiver receiving information corresponding to the identifier from the server.

16. The information delivery system of claim 15, wherein the identifier is a domain name used for internet connection, and the communication terminal is an internet connectable terminal.

17. The information delivery system of claim 15, wherein the storage stores advertisement information in association with identifiers, and advertisement information associated with the identifier is transmitted to the communication terminal.

18. The information delivery system of claim 15, wherein the communication terminal further includes a display displaying the information corresponding to the identifier transmitted from the server.

19. The information delivery system of claim 15, wherein the barcode is a two-dimensional barcode.
